(19) United States
(12) Patent Application Publication
(10) Pub. No.: US 2010/0230164 A1
(43) Pub. Date: Sep. 16, 2010

(54) COMPOSITIONS AND METHODS FOR INHIBITING LOST CIRCULATION DURING WELL OPERATION

(76) Inventor: Daniel Guy POMERLEAU, Calgary (CA)

Correspondence Address: MCGLEW & TUTTLE, PC, P.O. BOX 9227, SCARBOROUGH STATION, SCARBOROUGH, NY, 10510-9227, US

(21) Appl. No.: 12/495,251

(22) Filed: Jun. 30, 2009

Related U.S. Application Data
(63) Continuation-in-part of application No. 12/402,993, filed on Mar. 12, 2009.

(51) Int. Cl. C09K 8/035; B32B 5/16; C09K 8/16; C09K 8/24; C09K 8/20; E21B 7/00; E21B 47/00

(52) U.S. Cl. 175/40; 428/402; 507/145; 507/104; 507/117; 507/118; 507/111; 175/72

(57) ABSTRACT

Drilling fluid additive compositions are provided for use with synthetic, oil based, or water based drilling fluids. The combined additive and drilling fluid are effective for reducing lost circulation, seepage loss as well as wellbore strengthening and/or wellbore lining. The method includes injecting the drilling fluid and 0.01 or more pounds per barrel of a loss control additive including ground and sized pumice, barite, anthracite or dolomite.

### RELATED APPLICATION

This application is a continuation-in-part of U.S. patent application Ser. No. 12/402,993 filed Mar. 12, 2009.

### FIELD OF THE INVENTION

Drilling fluid additive compositions are provided for use with synthetic, oil based, or water based drilling fluids. The combined additive and drilling fluid are effective for reducing lost circulation, seepage loss as well as wellbore strengthening and/or wellbore lining. The method includes injecting the drilling fluid and 0.01 or more pounds per barrel of a loss control additive including ground and sized pumice, barite, dolomite or anthracite coal dust. In addition, sized additives are effective as proppants in various formations.

### BACKGROUND OF THE INVENTION

Boreholes created in the earth for extraction of mineral deposits such as oil and gas pass through numerous and varied geologic formations. These geologic formations have varied properties including numerous chemical and mechanical properties such as permeability, porosity, pore fluids, internal pore pressures, etc. Each of these properties are considered to some degree in the design and implementation of a drilling program. For example, material properties of the formation that affect well design include compressive strength, tensile strength, fracture initiation and propagation limits, porosity, Young's elastic modulus, Poisson ratio and bulk modulus.

Significant variations in formation pressures and their material properties, and formation fluids often require isolation and specific treatment. Such treatments include but are not limited to methods to increase fracture initiation pressure, the consolidation of fractured materials, sealing up thief or lost circulation zones, reducing permeability and porosity that is causing the loss and/or shutting off undesirable water or nuisance gas.

Such treatments include the use of steel casing or cement. When steel casing is used to isolate particular strata, these structures are expensive and will result in the overall reduction of the diameter of any lower sections of the excavation. This reduction can significantly affect potential production of gas and/or fluids from the well. In addition, the cost of these steel structures can significantly affect the economic justification for the well.

Drilling fluids, or drilling muds as they are often known, are generally slurries of clay solids, polymers and other fluid materials. Typically, a drilling mud is circulated down through the drill pipe, out the drill bit, and back to the surface through the annulus between the drill pipe and the borehole wall. Drilling fluids generally include one or more of viscosifiers or suspending agents, weighting agents, corrosion inhibitors, soluble salts, seepage loss control additives, bridging agents, emulsifiers, lubricants as well as other additives selected to impart desired properties to the drilling fluid.

Oil-based drilling fluids are comprised of oils, including for example, diesel, poly alpha olefins, mineral oils, propylene glycol, methyl glycoside, modified esters and ethers, and the like and mixtures thereof, and invert emulsions of oil in which water is dispersed in an oil-based medium. Oil based drilling fluids can be comprised entirely of oil, or more commonly, may contain water ranging in concentration from 10% up to 50%. In such a mixed oil and water system, water becomes the internal phase and is emulsified into the oil such that the oil becomes the external phase.

Drilling fluids can have a number of functions including lubricating the drilling tool and drill pipe which carries the tool, providing a medium for removing formation cuttings from the well, counterbalancing formation pressures to prevent the inflow of gas, oil or water from permeable or porous formations which may be encountered at various levels as drilling continues, preventing the loss of drilling fluids into permeable or porous formations, and holding the drill cuttings in suspension in the event of a shutdown in the drilling and pumping of the drilling mud. Drilling fluid additives can also form thin, low permeability filter cakes that can seal openings in the formation penetrated by the bit and/or act to reduce the unwanted influx of fluids and/or the loss of the drilling fluids to a permeable formation. A filter cake forms when the drilling fluid contains particles that are approximately the same size as the pore openings in the formation being drilled. A filter cake is an integral component of wellbore strengthening.

For a drilling fluid to perform the desired functions and allow drilling activities to continue, the drilling fluid must remain in the borehole. Frequently, undesirable formation conditions are encountered in which substantial amounts, or in some cases, practically all of the drilling fluid may be lost to the formation. Drilling fluid can leave the borehole through large or small fissures, or fractures in the formation or through a highly porous rock matrix surrounding the borehole.

Because fluid loss is a common occurrence in drilling operations, drilling fluids are typically formulated to intentionally seal porous formations during drilling in order to stabilize the borehole and control fluid loss. However, formations are frequently encountered that are so porous such that the loss of drilling fluids is increased beyond an acceptable limit despite the use of traditional lost circulation additives. In extreme situations, when the borehole penetrates a fracture in the formation through which most of the drilling fluid may be lost, drilling operations may be stopped until the loss circulation zone is sealed and fluid loss to the fracture is reduced. Typically these zones are isolated with steel casings or through the use of cement.

In some cases, fluid losses can be induced from increases in fluid density resulting in excessive hydrostatic pressure and subsequently induced fractures and the resulting loss of fluid into these fracture, or as a result of underground blowouts.

Underground blowouts are characterized as uncontrolled increases in wellbore pressures associated with the entry of pressurized fluids from adjacent formations that may cause fractures in the formations during well control operations or as the uncontrolled flow of reservoir fluids from one reservoir into the wellbore, along the wellbore, and into another reservoir.

During an underground blowout, this crossflow from one zone to another can occur when a high-pressure zone is encountered, with the result being that the well flows, and the drilling crew reacts properly and closes the blowout preventers (BOPs). Pressure in the annulus then builds up to the point at which a weak zone fractures. Depending on the pressure at which the fracturing occurs, the flowing formation can continue to flow and losses continue to occur in the fractured zone. Underground blowouts are historically one of the most expensive problems in the drilling arena, eclipsing the costs of even surface blowouts. In some cases, it may become necessary to drill a second kill well in order to remedy an underground blowout.

A review of the prior art indicates that many technical solutions have been proposed for dealing with the challenges facing a drilling engineering program and particularly to improve seepage loss and well strengthening.

However, there continues to be a need for improved additives and compositions of drilling fluids which can provide an in-situ method for dealing with many of the foregoing challenges of seepage loss control, wellbore strengthening and/or minimizing the risk and/or effects of underground blowouts with a cost effective and readily deployed methodology.

A review of the prior art shows various compositions and strategies have been employed in the past. For example, U.S. Patent Publication No. 20060276348 discloses the use of a method for creating a geosynthetic composite in-situ, which includes a reactive ester having at least one carbon-carbon double bond, preferably a vinyl ester of a C₉ to C₁₁ versatic acid or vinyl ester of a long chain fatty acid, or a combination thereof, at least one unsaturated thermoplastic elastomer soluble in the reactive ester, at least one di- or tri-functional acrylate or methacrylate monomer.

U.S. Pat. No. 3,701,384 discloses a method of sealing permeable areas in a formation by plugging the pores with a solid material. A slurry of finely divided inorganic solids is injected into the formation together with an aqueous colloidal dispersion of a water-insoluble metal hydroxide in dilute aqueous solution of an organic polymeric polyelectrolyte, preferably containing a high molecular weight polyacrylamide or hydrolyzed polyacrylamide. At low concentrations, between 0.01 and 0.2 percent by weight, the dissolved polymer causes the suspended solids to flocculate, thereby blocking pores in the formation. The tested inorganic solids included finely ground asbestos fibers and magnesium oxide. As is known, due to its carcinogenic nature, asbestos is undesirable for widespread commercial use.

U.S. Pat. Nos. 4,683,949 and 4,744,419 disclose a method for sealing permeable areas in formations using polymers cross-linked in-situ. Both patents note that effective polymer/cross-linking agents must be supplied sequentially with great care to prevent the cross-linked polymer from setting up too early.

In addition, various formation agents and additives are known in the art to form formation seals and/or filter cakes on the wall of a well bore. These include sugar cane fibers or bagasse, flax, straw, ground hemp, cellophane strips, ground plastics, ground rubber, mica flakes, expanded perlite, silica slag, ground fir bark, ground redwood bark and fibers, grape extraction residue, cottonseed hulls, cotton balls, ginned cotton fibers, cotton linters, waxes, gilsonite, asphaltine, calcite, dolomite, and the like.

However, the use of cellulose fibers has generally been for control of seepage loss or lost circulation and differential sticking, rather than for the stabilization of shale formations. To prevent further seepage loss, a number of different cellulose materials have been added to prior art drilling fluids in an effort to reduce the permeability of the formation being drilled. Such prior known cellulose fiber materials can include fibrous, flake, and granular ground forms, and combinations thereof. Representative of such cellulose fibers include nut and seed shells or hulls, such as, for example, pecan, almond, walnut, peach, brazil, coconut, peanut, sunflower, flax, cocoa bean, cottonseed, rice, linseed, oat, and the like. See for example, U.S. Pat. No. 5,004,553 (House, et al.); U.S. Pat. No. 2,799,647 (Borchardt); and U.S. Pat. Nos. 4,460,052 and 4,498,995 (Gockel).

Further still, there has been a need for a new class of compounds that can be used as effective proppants in fracturing operations.

### SUMMARY OF THE INVENTION

In accordance with the invention, drilling fluid additives, drilling fluid compositions and methods for reducing lost circulation, seepage loss of drilling fluids and underground blowouts in drilling operations are provided.

In a first embodiment, a drilling fluid additive for reducing circulation loss during drilling operations is provided comprising ground pumice, barium, dolomite or anthracite having an average particle size between 100 and 4000 microns.

In a second embodiment, a drilling fluid composition comprising a liquid carrier and a drilling fluid additive is provided including any one of or a combination of ground pumice, barium, dolomite or anthracite having an average particle size between 100 and 4000 microns.

In further embodiments, the drilling fluid composition is characterized by one or more of the following properties:
the additive is mixed with the liquid carrier such that the concentration of additive in the liquid carrier is greater then 0.01 pounds per barrel (ppb) of liquid carrier;
the additive is barite and the concentration is 0.01-700 ppb;
the additive is pumice and the concentration is 0.01-300 ppb;
the additive is dolomite and the concentration is 0.01-300 ppb;
the additive is anthracite and the concentration is 0.01-300 ppb;
the concentration is less than 48% by volume additive in liquid carrier;
the additive has an average particle size between 100 and 4000 microns;
the ground pumice has a particle size distribution of 600 to 2000 microns;
the ground pumice has a particle size distribution of 250 to 1400 microns;
the ground pumice has a particle size distribution of 180 to 425 microns;
the anthracite has a particle size 100-4000 microns.

In further embodiments, the drilling fluid includes a secondary additive selected from any one of or a combination of hydrophobic synthetic fibrous particles, comminuted particles of plant and mineral materials, weighting materials, and gelling agents.

The hydrophobic synthetic fibrous particles may be selected from any one of or a combination of nylon, rayon, polyolefin fibers.

The comminuted particles of plant and mineral materials may be selected from particles derived from nut and seed shells or hulls including peanut, almond, brazil, cocoa bean, coconut, cotton, flax, grass, linseed, maize, millet, oat, peach, peanut, rice, rye, soybean, sunflower, walnut, wheat; rice fractions including rice tips, rice straw and rice bran; crude pectate pulp; peat moss fibers; flax; cotton; cotton linters; wool; sugar cane; paper; shredded paper; ground hemp; paper pulp; cellophane strips; ground bark; bagasse; bamboo; corn stalks; tree fractions including sawdust, wood or bark; straw; cork; dehydrated vegetable matter; whole or ground corn cobs; corn cob fractions including light density pith core, corn cob ground woody ring portion, corn cob coarse or fine chaff portion; cotton seed stems; flax stems; wheat stems; sunflower seed stems; soybean stems; maize stems; rye grass stems; millet stem; gilsonite; asphaltine; waxes; and calcium carbonate.

The weighting materials may be selected from any one of or a combination of barite, barium sulfate, calcium carbonate, galena, hematite, magnetite, iron oxides, ilmenite, siderite, celestite, dolomite, calcite, manganese oxides, zinc oxide, and zirconium oxides.

The gelling agents may be selected from any one of or a combination of starch or derivatized starches and chemically modified starches including carboxymethyl starch, hydroxyethyl starch, hydroxypropyl starch, acetate starch, sulfamate starch, phosphate starch, nitrogen modified starch, starch cross-linked with aldehydes, epichlorohydrin, borates, and phosphates.

In a further embodiment, the invention provides a method for ameliorating seepage loss while drilling a subterranean well comprising the steps of:
a. monitoring seepage loss while drilling;
b. circulating a synthetic oil, oil, or water based drilling mud into the drill string wherein the drilling fluid comprises a liquid carrier and an additive of ground pumice, barite, dolomite or anthracite or a combination thereof and wherein the liquid carrier is a synthetic, oil, or water based drilling mud and the additive is added to the liquid carrier at a concentration of greater then 0.01 pounds per barrel of liquid carrier.

In further embodiments, the additive is barite and the concentration is 0.01-700 ppb; the additive is pumice and the concentration is 0.01-300 ppb; the additive is

In another embodiment, the concentration is less than 48% by volume additive in liquid carrier.

In a further embodiment of the method, the additive has an average particle size between 100 and 4000 microns.

In a still further embodiment, the concentration of additive is increased during circulation.

In yet further embodiments of the method:
step b) is initiated with an additive having an average particle size in the lower half of the range of 100-4000 microns and wherein step b) is repeated with an additive having a larger average particle size than the lower half;
step b) is initiated with an additive having an average particle size in the upper half of the range of 100-4000 microns and wherein step b) is repeated with an additive having a smaller average particle size than the upper half;
step b) is initiated with an additive having an average particle size in the lower quartile of the range of 100-4000 microns and wherein step b) is repeated with an additive having a larger average particle size than the lower quartile; or,
step b) is initiated with an additive having an average particle size in the upper quartile of the range of 100-4000 microns and wherein step b) is repeated with an additive having a smaller average particle size than the upper quartile.

In another embodiment, the invention provides a method of recognizing and controlling an underground blowout in a subterranean formation comprising the steps of:
a. monitoring surface pressure within a well to detect a pressure increase indicating fluid influx into the well;
b. closing in the well in response to the pressure increase;
c. monitoring surface pressure and detecting an underground blowout if well pressure drops and fluid loss increases above threshold values;
d. circulating a drilling fluid composition comprising a liquid carrier and a drilling fluid additive including any one of or a combination of ground pumice, barium, dolomite or anthracite having an average particle size between 100 and 4000 microns; and,
e. monitoring the fluid loss and adjusting the size and/or concentration of drilling fluid additive in response to changes or lack of changes in the fluid loss.

In accordance with a further embodiment, novel proppant materials are described. In particular, proppants for use in downhole fracturing are described comprising any one of or a combination of ground pumice, barium, anthracite and dolomite. In preferred embodiments, the proppant is anthracite or pumice.

### BRIEF DESCRIPTION OF THE DRAWINGS

The invention is described with reference to the drawings in which:

FIG. 1 is a graph showing required barite particle size distribution for use in drilling fluid in accordance with American Petroleum Institute (API) standard API 13A.

### DETAILED DESCRIPTION OF THE INVENTION

In accordance with the invention, improved seepage control drilling fluid additives, drilling fluid compositions and methods of use are described. The additives, compositions and methods are designed to decrease or eliminate seepage loss and lost circulation of oil, synthetic, water and mixed oil/water drilling fluids in a drilling operation. The invention can be supplied as an additive for drilling fluid, or may form part of a drilling fluid composition. That is, the additive may be added to a drilling fluid as needed when excessive seepage or circulation loss problems are encountered during drilling or form part of an initial drilling fluid.

The general method of the invention generally includes injecting a drilling fluid with a loss control additive together wherein the loss control additive has mechanical properties enabling the effective creation of a high tensile strength barrier within a lost circulation zone to reduce fluid loss.

The loss prevention additives may be used with oil-based, water-based or synthetic drilling fluid systems, including various mineral oil and diesel based drilling fluids. As will be described in greater detail below, preferred loss prevention additives include ground pumice, barium sulfate (hereinafter “barite”), dolomite and anthracite and other additives having desired mechanical properties based on size and hardness.

### Applications

The additives and compositions in accordance with the invention provide superior results in terms of improved loss circulation, wellbore strengthening and filter cake development in a wider variety of formations. For example, the compositions can be effectively used in the sealing of low pressure sands, sealing fractures, the stabilization of shale sections, and the reduction of differential sticking tendencies in low pressure sands.

Further still, the additives of the present invention can also be used in coring fluids and oil-based workover and completion. The additives of the present invention can be utilized with drilling fluids at both low concentrations for routine use during normal drilling operations and then adjusted to higher concentrations when necessary for applications (such as pill applications) to prevent further circulation loss or seepage if the drill bit hits a formation causing a drop in pressure and loss of drilling fluid.

### Additives and Compositions

Generally, the additives of the present invention are characterized in terms of their particle size and mechanical strength. Compositions of the present invention are characterized in terms of the concentration of an additive within known drilling fluids. For example, an additive may be mixed with synthetic and oil based drilling fluids in concentrations from 0.01 or greater pounds per barrel (ppb) of drilling fluid, depending on the formation conditions so as to create a general use drilling fluid composition. In other embodiments, when required in spot or pill applications during drilling, concentrations of between 10 and 50 ppb can be employed to prevent further loss due to unexpected seepage, or in an effort to seal micro-fractured formations.

In further embodiments, the additives of the present invention can be used alone (within a drilling fluid) or in combination with a variety of other materials that may provide secondary sealing and/or drilling fluid weight including but not limited to:
1. Hydrophobic synthetic fibrous particles suitable to prevent seepage and circulation loss including nylon, rayon, polyolefin fibers and combinations thereof.
2. Comminuted particles of plant and mineral materials including particles derived from nut and seed shells or hulls such as those of peanut, almond, brazil, cocoa bean, coconut, cotton, flax, grass, linseed, maize, millet, oat, peach, peanut, rice, rye, soybean, sunflower, walnut, wheat; various portions of rice including the rice tips, rice straw and rice bran; crude pectate pulp; peat moss fibers; flax; cotton; cotton linters; wool; sugar cane; paper; shredded paper; ground hemp; paper pulp; cellophane strips; ground bark; bagasse; bamboo; corn stalks; various tree portions including sawdust, wood or bark; straw; cork; dehydrated vegetable matter; whole ground corn cobs; or various plant portions of the corn cob light density pith core, the corn cob ground woody ring portion, the corn cob coarse or fine chaff portion, cotton seed stem, flax stems, wheat stems, sunflower seed stems, soybean stems, maize stems, rye grass stems, millet stem gilsonite, Asphaltine, waxes, calcium carbonate, dolomite, and the like, and various mixtures of these materials.
3. Known weighting materials, including barite, barium sulfate, calcium carbonate, galena, hematite, magnetite, iron oxides, ilmenite, siderite, celestite, dolomite, calcite, manganese oxides, zinc oxide, zirconium oxides, and the like. As known, weighting materials generally function to increase the density of the drilling fluid. Generally, a drilling fluid should have a sufficient density to provide a hydrostatic pressure that is greater than formation fluid pressures to prevent blowout and/or the uncontrolled flow of fluids from the formation into the well. However, the density must not be too high to cause further seepage loss.
4. Gelling agents, such as starch or derivatized starches. Any suitable granular starch or mixture of starches may be used in the present invention. Accordingly, as used herein, the term “starch” is understood to include one or more natural starches, one or more chemically modified starches, and mixtures of one or more natural or/and/or chemically modified starches. Natural starches that may be employed in the invention include, but are not limited to those of potato, wheat, tapioca, rice, corn, roots having a high starch content, and the like. Waxy starches, such as for example, waxy cornstarch, is often preferred as a gelling agent. Chemically modified starches can be those derived from natural starches by chemical reaction of the natural starch with a suitable organic reactant. Chemically modified starches which may be used in the invention can include, but are not limited to, carboxymethyl starch, hydroxyethyl starch, hydroxypropyl starch, acetate starch, sulfamate starch, phosphate starch, nitrogen modified starch, starch cross-linked with aldehydes, epichlorohydrin, borates, and phosphates, and mixtures thereof. Various starches are disclosed in U.S. Pat. Nos. 4,652,384; 4,822,500; 4,422,947; 4,123,366; 5,804,535; 5,851,959 and 5,948,733.

### Particle Size

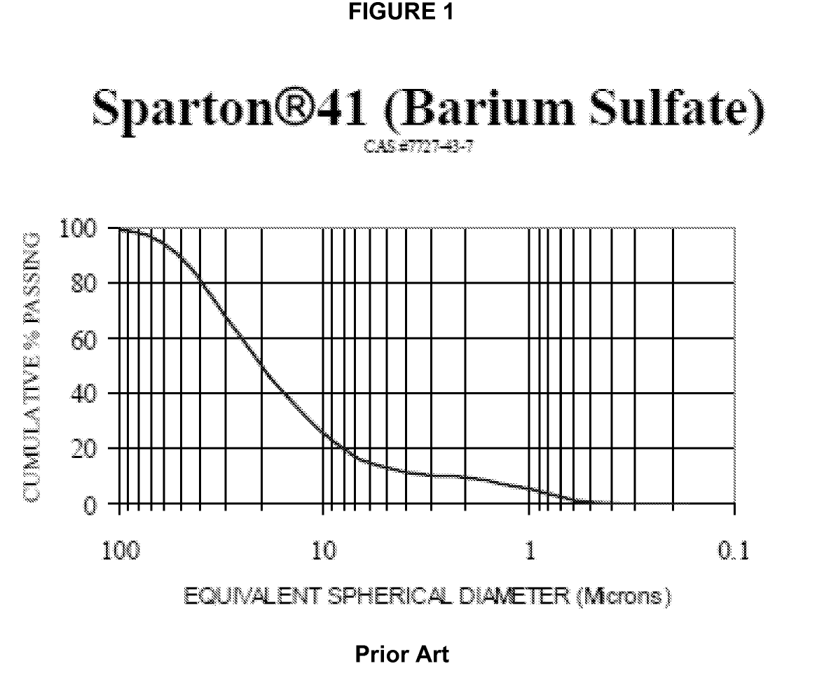

As is known, in a typical drilling operation, weighting agents are utilized such that the particle size of the weighting agent effectively contributes to the density of the fluid by i) remaining suspended in the solution without rapid settling and ii) so as to not adversely interfere with normal solids separation of drill cuttings from drilling fluid at surface. As such, and in accordance with American Petroleum Institute (API) standards, the API 13A specification requires barite particle size for use in drilling fluid to be as shown in FIG. 1. That is, for use as a weighting agent, the API specifies that the particle size distribution of barite is smaller than 100 microns with roughly 60% of barite particle between 20-80 microns. In addition, U.S. Pat. No. 6,180,573 specifies that barite particles are at least 85% by weight particles less than 75 microns and greater than 6 microns in equivalent spherical diameter. Other industry known API specifications dating back to 1981 specify 95%-45 microns (325 mesh).

In accordance with the invention, additives such as pumice, barite or dolomite have an increased particle size that is added to a drilling fluid alone or in combination with other sized materials in the drilling fluid.

Table 1 shows effective particle size distributions of a pumice additive of the present invention for different commercial pumice products designated A-E. As shown, particle sizes range from 180-2000 microns plus.

TABLE 1
Particle Size Distributions for Various Commercial Pumice Products

| Mesh Size | A | B | C | D | E | Microns |
|---|---|---|---|---|---|---|
| 10 | | | | | [symbol] | 2000+ |
| 14 | | | [symbol] | [symbol] | [symbol] | 1400 |
| 30 | | | [symbol] | [symbol] | [symbol] | 600 |
| 40 | [symbol] | [symbol] | [symbol] | [symbol] | | 425 |
| 50 | [symbol] | [symbol] | [symbol] | [symbol] | | 300 |
| 60 | [symbol] | [symbol] | [symbol] | [symbol] | | 250 |
| 80 | [symbol] | [symbol] | | | | 180 |
| Unit wt | 50 | 47 | 41 | 43 | 43 | |
| (lbs/cf) | | | | | | |
| Average | 329 | 386 | 503 | 950 | 1330 | |
| Particle | | | | | | |
| Size | | | | | | |
| (microns) | | | | | | |
| Sp. Gr. | 2.068 | 2.04 | 1.87 | 1.76 | 1.8 | |

### Hardness

Importantly, for effective loss circulation control and well-bore strengthening in accordance with the invention, additives having a high hardness relative to the formation are required. With reference to Table 2, the hardness of various additives and known loss circulation agents are compared in accordance with a number of known hardness tests.

TABLE 2
Comparison of Measured Hardness of Various Substrates by Various
Hardness Test

| Hardness | | | | | | | | |
|---|---|---|---|---|---|---|---|---|
| Test | Name | Pumice | Dolomite | Barite | Cal-Carb | Mica | Gilsonite | Graphite |
| Moh | Mineral Hardness | 5.5 | 3.5-4 | 3 | 2.5 | 2.5 | 2 | 1.5 |
| HB (3000) | Brinell 10 mm | >> | 217-299 | 150 | 97 | 97 | << | << |
| | Standard 3000 kgf | | | | | | | |
| HB (500) | Brinell 10 mm | >> | 189+ | 136 | 90 | 90 | << | << |
| | Standard 500 kgf | | | | | | | |
| HB | Brinell 10 mm | 629 | 217-299 | 150 | 97 | 97 | << | << |
| (Tungsten | Tungsten 3000 kgf | | | | | | | |
| 3000) | | | | | | | | |
| HB | Brinell | 2.44 | 4.1-3.5 | 4.90 | << | << | << | << |
| (Indentation) | Indentation (mm) | | | | | | | |
| HK | Knoop | 705 | 239-327 | 169 | 117 | 117 | << | << |
| HRA | Rockwell A-Scale | 81 | 60-66 | << | << | << | << | << |
| HRB | Rockwell B-Scale | >> | 97+ | 81 | 57 | 57 | << | << |
| HRC | Rockwell C-Scale | 59 | 19-32 | << | << | << | << | << |
| HRD | Rockwell D-Scale | 70 | 39-49 | << | << | << | << | << |
| HRF | Rockwell F-Scale | >> | >> | 98 | 89 | 89 | << | << |
| HR-15N | Rockwell Superficial | 90 | 69-76 | << | << | << | << | << |
| | 15N | | | | | | | |
| HR-15T | Rockwell Superficial | >> | 92+ | 87 | 79 | 79 | << | << |
| | 15T | | | | | | | |
| HR-30N | Rockwell Superficial | 76 | 40-52 | << | << | << | << | << |
| | 30N | | | | | | | |
| HR-30T | Rockwell Superficial | >> | 82+ | 71 | 54 | 54 | << | << |
| | 30T | | | | | | | |
| HR-45N | Rockwell Superficial | 65 | 18-33 | << | << | << | << | << |
| | 45N | | | | | | | |
| HR-45T | Rockwell Superficial | >> | 71+ | 55 | 29 | 29 | << | << |
| | 45T | | | | | | | |
| HS | Shore Scleroscope | 79 | 33-44 | 23 | 16 | 16 | << | << |
| Approx. TS | Tensile Strength | 2387 | 724-998 | 510 | 338 | 338 | << | << |
| | MPa (Approx.) | | | | | | | |
| HV | Vickers | 669 | 229-315 | 157 | 102 | 102 | 61 | 37 |

In the table, each hardness test includes either a number, or a “<<” or “>>” symbol. A number indicates that the tested material could produce a hardness value from that test whereas “<<” indicates that the hardness test destroyed the material such that no meaningful hardness value was obtained and a “>>” indicates that the hardness test could not generate a meaningful hardness value as the material was too hard for that test.

As shown, pumice and dolomite showed high hardness values for each test as compared to all other materials and particularly those materials typically used as seepage control agents including calcium carbonate, mica, gilsonite and graphite.

### Methods of Use

As will be explained in greater detail below by way of example, the optimized particle size and mechanical properties of the particles are effective to seal fractures, pore throats, and other thief zones in a wellbore, strengthen the wellbore while at the same time providing density to the drilling fluid on its own or in conjunction with other weighting agents within the API specification.

In operation, during drilling and in the event of recognized seepage loss, an operator will adjust the concentration of additive within the drilling fluid such that the concentration of additive is increased to a level such that an effective balance is achieved between seepage loss and fluid density.

Thus, the operator will seek to increase the concentration of the seepage loss agent in the drilling fluid such that the seepage loss is effectively minimized. As known to those skilled in the art, drilling fluid viscosity, hydrostatic pressure, circulation rate and well pressure are control parameters that an operator will choose to adjust so as to effectively control seepage loss. As well, for certain formations, an operator may choose to add an additive of a larger or smaller particle size depending on the recognized effect.

More specifically, the operator can utilize larger particle size additives preferably in the range of 100 and 4000 microns and adjust the concentration of additive during circulation in response to observed data from the well. Quantitatively, circulation may be initiated with an additive having an average particle size in the lower half of the range of 100-4000 microns wherein, in response to observed data, circulation is repeated with an additive having a larger average particle size than the lower half particle size.

In another embodiment, circulation may be initiated with an additive having an average particle size in the upper half of the range of 100-4000 microns wherein, in response to observed data, step b) is repeated with an additive having a smaller average particle size than the upper half particle size.

Further still, circulation may initiated with an additive having an average particle size in the lower quartile of the range of 100-4000 microns wherein, in response to observed data, circulation is repeated with an additive having a larger average particle size than the lower quartile particle size. Alternatively, circulation may be initiated with an additive having an average particle size in the upper quartile of the range of 100-4000 microns and wherein, in response to observed data, circulation is repeated with an additive having a smaller average particle size than the upper quartile.

In the particular case of an underground blowout in a subterranean formation, the operator may effectively utilize the additives to minimize the effect of an underground blowout. In this case, the operator during regular monitoring of surface pressure within a well, detect a pressure increase indicating fluid influx into the well. In response to the pressure increase the operator may close in the well and thereafter detect an underground blowout if the well pressure drops and fluid loss increases above threshold values. By circulating a drilling fluid composition including the drilling fluid additives described and further monitoring of the fluid loss together with adjusting the size and/or concentration of drilling fluid additive in response to changes or lack of changes in the fluid loss, an underground blowout can be effectively controlled.

Ultimately, the size of the passages through the circulating jets in the drill bit can be a limiting factor for absolute maximum particle size of the additives in “While Drilling Operations” however for open-ended operations where the drill bit has been removed a much broader particle size range is achievable. However, the particle size of the additive should be of a small enough size so as to be able to enter the formation through fissures, small fractures and large pores. Generally, particles should be sized according to the properties of the formation and the lost circulation zone.

As additive particles are pumped downhole, they are ejected from the drill bit wherein as a result of hydrostatic pressure, pumping pressure, formation and particle properties will be forced into cracks and fissures in the formation. As a result of the increased hardness of the additive particles, it is understood that the particles under appropriate impact and pressure conditions, embed themselves in the cracks and fissures in a multi-layer matrix that reduces the channels for drilling fluid escape while simultaneously providing a layer of strength to the well bore wall.

That is, in order to effectively provide loss circulation control and well bore strengthening an additive particle must wedge and lock in the mouth of the fracture. Assuming that a fracture is generally wedge-shaped with a wider mouth adjacent the borehole, the initial width of the fracture mouth loosely defines the particle size which in turn can be used to determine a concentration of additive.

As such, the concentration of the additive is directly proportional to the volume and density of the additive having a particle size equal to the average fracture width and inversely proportional to the average fracture volume and the proportion of the additive having a particle greater than the average fracture width.

Advantageously, by introducing high tensile strength agents, the shear strength of the well bore wall is increased such that an increased mud weight can be employed without inducing fluid losses into the formation(s) exposed.

Subsequent to or simultaneously with, a plastering agent may be introduced into the drilling fluid to provide secondary sealing of the microchannels within the primary matrix or those channels not affected by the additive.

Suitable plastering agents may be Montan wax, mica, graphite, gilsonite and/or other agents identified above.

Pumice is a preferred loss circulation additive. Known as amorphous aluminum silicate, pumice is characterized as having a highly porous structure (typically about 90% porosity) and thus allows for the flow of fluid through the particles. Downhole, this has the beneficial property of enabling pressure to equalize between the fluid column and the fracture or pore to be sealed/bridged which is believed to help in the initial plastering of the thief zone. These pores may be subsequently sealed by a colloidal, smaller particle size plastering agent.

Commercially, a variety of different granulations of pumice are available from a very coarse granule (4.75 mm and finer) to a very fine powder (45 microns and finer). Typical granulations useful for the subject invention are described in Table 1.

Other technical advantages of pumice are its lower average specific gravity; 1870 kg/m³ (Bulk Density 250 kg/m³) as compared to calcium carbonate 2750 kg/m³ (Bulk Density 700 kg/m³) allowing for it to be incorporated into drilling fluid without raising the density of the drilling fluid as high as might occur with ground and sized calcium carbonate or barite.

In addition, the high porosity of pumice may additionally provide better return permeability for pay zones penetrated with drilling fluids using pumice for seepage control over those laden with the more traditional materials discussed herein.

In other embodiments, the high matrix strength and porosity of pumice also make pumice an excellent product for filling natural and induced fractures in hydrocarbon producing horizons, for example in fracturing operations to replace frac-sand currently employed in such applications. Further the ability to equalize pressure between the fluid column and the fracture is understood to improve proppant placement.

Anthracite is another loss circulation additive. Anthracite is a hard coal having the highest fixed-carbon content and the lowest amount of volatile material of the classifications of coal. Anthracite contains approximately 87.1% carbon, 9.3% ash, and 3.6% volatile matter. It has a glossy black colour and sheen and a crystal structure characterized by a conchoidal fracture. Hardness properties are shown in Table 3

TABLE 3
Measured Properties and Hardness of Anthracite by Various
Hardness Tests

| Symbol | Name | Anthracite Coal |
|---|---|---|
| Moh | Mineral Hardness | 3-4 |
| HB (3000) | Brinell 10 mm Standard 3000 kgf | 150-299 |
| HB (500) | Brinell 10 mm Standard 500 kgf | 136-190 |
| HB (Tungsten | Brinell 10 mm Tungsten 3000 kgf | 150-300 |
| 3000) | | |
| HB (Indentation) | Brinell Indentation | 4.9-3.5 mm |
| HK | Knoop | 169-327 |
| HRA | Rockwell A-Scale | 52-66 |
| HRB | Rockwell B-Scale | 81-97+ |
| HRC | Rockwell C-Scale | 14-32 |
| HRD | Rockwell D-Scale | 29-50 |
| HRF | Rockwell F-Scale | 98+ |
| HR-15N | Rockwell Superficial 15N | 52-76 |
| HR-15T | Rockwell Superficial 15T | 92+ |
| HR-30N | Rockwell Superficial 30N | 30-52 |
| HR-30T | Rockwell Superficial 30T | 71-82+ |
| HR-45N | Rockwell Superficial 45N | 12-33 |
| HR-45T | Rockwell Superficial 45T | 71+ |
| HS | Shore Scleroscope | 23-44 |
| Approx. TS | Tensile Strength (Approx.) | 510-998 Mpa |
| HV | Vickers | 157-315 |
| Coefficient of | | 0.14 |
| Friction | | |
| Density kg/m³ | | 1.51 |

As above, a number indicates that the tested material could produce a hardness value from that test.

Table 4 shows fluid properties of an oil based mud comprising a base fluid of HT30N oil (97% by volume) and Water (3% by volume). Test samples were subjected to known testing procedures. The median particle size of the added coal was approximately 2000 microns.

TABLE 4
Properties of Oil Based Mud with Anthracite
Base Fluid HT30N 97/3 Oil Based Mud (OBM)

| | | | | |
|---|---|---|---|---|
| Oil Volume | 3.000 | 2.650 | 2.300 | 1.950 |
| (litres) | | | | |
| Cell # | 2253 | 2259 | 2269 | 2261 |
| Added Coal | | 6.79 | 12.44 | 12.44 |
| (kg/m³) | | | | |
| Diethylene | | | | 1.60 |
| triamine | | | | |
| (DETA) (kg/m³) | | | | |

Before Hot
Rolling (BHR)

| | | | | |
|---|---|---|---|---|
| Measurement | 50 | 50 | 50 | 50 |
| Temp (° C.) | | | | |
| Viscosity at | | | | |
| varying shear | | | | |
| rates (s⁻¹) | | | | |
| 600 | 26.5 | 25.5 | 24 | 23 |
| 300 | 18.5 | 18.5 | 17 | 16.5 |
| 200 | 15 | 15 | 14 | 13 |
| 100 | 11.5 | 12 | 11 | 10.5 |
| 6 | 8.5 | 9 | 8 | 7.5 |
| 3 | 8.5 | 9 | 8.5 | 8 |
| ES (Volts) | 2074 | 2096 | 2388 | 2338 |
| Plastic | 8.0 | 7.0 | 7.0 | 6.5 |
| Viscosity | | | | |
| (mPa · s) | | | | |
| Yield Point (Pa) | 5.3 | 5.8 | 5.0 | 5.0 |
| After Hot | | | | |
| Rolling (AHR) | | | | |
| (Hot rolling at | | | | |
| 90° C.) | | | | |
| Measurement | 70 | 70 | 70 | 70 |
| Temp (° C.) | | | | |
| Viscosity at | | | | |
| varying shear | | | | |
| rates (s⁻¹) | | | | |
| 600 | 11.5 | 13 | 12 | 12.5 |
| 300 | 8 | 9 | 8 | 8 |
| 200 | 6.5 | 7.5 | 6.5 | 6.5 |
| 100 | 5 | 5.5 | 4.5 | 4.5 |
| 6 | 3 | 3 | 2.5 | 2 |
| 3 | 3 | 3 | 2.5 | 2 |
| ES (Volts) | 2421 | 2558 | 3456 | 2000 |
| Plastic | 3.5 | 4.0 | 4.0 | 4.5 |
| Viscosity | | | | |
| (mPa · s) | | | | |
| Yield Point (Pa) | 2.3 | 2.5 | 2.0 | 1.8 |

HTHP filtration

| | | |
|---|---|---|
| Temp ° C. | 100 | 100 |
| Volume (mls) | 22 | 10 |
| Cake (mm) | 2 | 2 |
| Filtrate Color | Clear | Clear |

The results indicate that anthracite would be effective as a bridging agent. In particular, the HTHP tests show that as compared to the sample without coal, substantially less filtrate was obtained.

### Use of Additives as Proppants

In a further embodiment, the additives are effective as proppants in various fracturing operations. As proppants, and depending on the formation, proppant particle size can be of a similar size to those where they are effective as bridging agents, or alternatively, of a larger size. In particular, at shallower formation depths, proppant may range up to 35,000 microns in average particle size.

In particular, anthracite, when subjected to fracturing forces will fracture in response to applied stress in a conchoidal manner such that rounded surfaces of varying amplitude and curvature will be formed. As a result, the shapes are random and hence pack poorly thus contributing to superior porosity.

Further, anthracite has a relatively low coefficient of friction and thus has improved flow characteristics as compared to higher coefficient of friction materials.

With respect to pumice, while the crush characteristics of pumice are not inherently suited to preserving large particle sizes at typical pressures seen in various fracturing operations, the characteristics of pumice may make it suitable as a proppant at higher depths where conventional proppants such as Ottawa sand may also be crushed.

### EXAMPLES

A test well was drilled by Orleans Energy of Calgary, Alberta Canada. During drilling of an intermediate section of the well, daily losses of drilling fluid to the wellbore were calculated to be in excess of 10 m³/day. To remedy these losses, additions of cement grade gilsonite, humalite and a Mineral wax were used to control these losses. The use of this material was predicated on its successful application on other nearby wells. After 2 days, the losses stabilized at 10 m³/day. Further increases in the above combination of loss prevention additives did not produce any further variance in losses.

Additions of the foregoing blended material were suspended and additions of 325 mesh/grind calcium carbonate were made to the fluid. Fluid losses were not reduced after 48 hours.

The calcium carbonate additions were suspended and Hess 1½# grind pumice addition was initiated. The pumice concentration was adjusted to 1.5 kg/m³ or 0.53 ppb (parts per barrel), losses were noticeably reduced and additions of the pumice continued until 33 sxs or 825 kilograms had been made. Losses at that time were reduced to 0.125 m³/day with a final concentration in the system of 33 sxs×25 kg/130 m³=6.3 kg/m³ or 2.2 ppb.

In another example, in another well, a fracture was drilled immediately below a liner point (steel casing). Upon drilling the fracture, fluid losses were on the order of 5 m³/hour with a fluid density of 1360 kg/m³. There was an anticipated requirement for a fluid density of >1700 kg/m³, thus it was required that the fracture be sealed and capable of withstanding the higher required fluid pressure. As shown in Table 4, a first pill (1) was formulated comprising Montan Wax, Gilsonite, Nut Plug, Humilite and other fibrous materials. The first pill was displaced into the wellbore, located next to the fracture and subsequently squeezed into the formation. A “leak-off” pressure test was initiated and a maximum mud weight pressure of 1415 kg/m³ was achieved which was below the anticipated requirement. Subsequently a second pill (2) was formulated using Pumice and the sized Barite as supplemental additives. The second pill was displaced and squeezed and another “leak-off” test was initiated. The second pill increased the wellbore strength such that it could withstand a maximum mud weight of 1650 kg/m³ which was a significant improvement over the first pill formulation.

TABLE 5
Pill Formulations

| | Size (m³) | | |
|---|---|---|---|
| | Product Wt. | 12 | Product Wt. |
| Product | kg/sx | Number of sx | kg/m³ |
| Pill (1) | | | |
| Cal Carb 0 | 25 | 30 | 62.5 |
| Cal Carb Poultrv | 25 | 40 | 83.3 |
| Cal Carb Supercal | 25 | 30 | 62.5 |
| Fibre Fluid Fine | 11.3 | 25 | 23.5 |
| Flake | 11.3 | 15 | 14.1 |
| Kwik Seal Med | 20 | 40 | 66.7 |
| Mica Fine | 25 | 40 | 83.3 |
| Montan | 8 | 10 | 6.7 |
| Humilite | 8 | 10 | 6.7 |
| Gilsonite | 8 | 10 | 6.7 |
| Sawdust | 7.3 | 35 | 21.3 |
| Walnut Fine | 22.7 | 40 | 75.7 |
| Walnut Coarse | 22.7 | 40 | 75.7 |
| Total LCM | | | 588.6 |
| Pill (2) | | | |
| Pumice | 25 | 40 | 83.3 |
| TripSeal (Sized | 40 | 40 | 133.3 |
| Barite) | | | |
| Fibre Fluid Fine | 11.3 | 25 | 23.5 |
| Flake | 11.3 | 15 | 14.1 |
| Kwik Seal Med | 20 | 40 | 66.7 |
| Mica Fine | 25 | 40 | 83.3 |
| Montan | 8 | 10 | 6.7 |
| Humilite | 8 | 10 | 6.7 |
| Gilsonite | 8 | 10 | 6.7 |
| Sawdust | 7.3 | 35 | 21.3 |
| Walnut Fine | 22.7 | 40 | 75.7 |
| Walnut Coarse | 22.7 | 40 | 75.7 |
| Total LCM | | | 597.0 |

Although the present invention has been described and illustrated with respect to preferred embodiments and preferred uses thereof, it is not to be so limited since modifications and changes can be made therein which are within the full, intended scope of the invention as understood by those skilled in the art.

1. A drilling fluid additive for reducing circulation loss during drilling operations comprising ground pumice, barium, anthracite or dolomite having an average particle size between 100 and 4000 microns.

2. A drilling fluid composition comprising a liquid carrier and a drilling fluid additive including any one of or a combination of ground pumice, barium, anthracite or dolomite having an average particle size between 100 and 4000 microns.

3. A drilling fluid composition as in claim 2 characterized in that the additive is mixed with the liquid carrier such that the concentration of additive in the liquid carrier is greater then 0.01 pounds per barrel (ppb) of liquid carrier.

4. A drilling fluid composition as in claim 3 wherein the additive is barite and the concentration is 0.01-700 ppb.

5. A drilling fluid composition as in claim 3 wherein the additive is pumice and the concentration is 0.01-300 ppb.

6. A drilling fluid composition as in claim 3 wherein the additive is dolomite and the concentration is 0.01-300 ppb.

7. A drilling fluid composition as in claim 3 wherein the concentration is less than 48% by volume additive in liquid carrier.

8. A drilling fluid as in claim 3 wherein the additive has an average particle size between 180 and 4000 microns.

9. The drilling fluid of claim 3 where the additive has an average particle size between 600 and 2000 microns.

10. The drilling fluid of claim 3 where the additive has an average particle size between 750 and 1400 microns.

11. The drilling fluid of claim 3 where the additive has a particle size distribution of 180 to 425 microns.

12. The drilling fluid of claim 3 further comprising a secondary additive selected from any one of or a combination of hydrophobic synthetic fibrous particles, comminuted particles of plant and mineral materials, weighting materials and gelling agents.

13. A drilling fluid composition as in claim 12 wherein the hydrophobic synthetic fibrous particles are selected from any one of or a combination of nylon, rayon, polyolefin fibers.

14. A drilling fluid composition as in claim 12 wherein the comminuted particles of plant and mineral materials are selected from particles derived from nut and seed shells or hulls including peanut, almond, brazil, cocoa bean, coconut, cotton, flax, grass, linseed, maize, millet, oat, peach, peanut, rice, rye, soybean, sunflower, walnut, wheat; rice fractions including rice tips, rice straw and rice bran; crude pectate pulp; peat moss fibers; flax; cotton; cotton linters; wool; sugar cane; paper; shredded paper; ground hemp; paper pulp; cellophane strips; ground bark; bagasse; bamboo; corn stalks; tree fractions including sawdust, wood or bark; straw; cork; dehydrated vegetable matter; whole or ground corn cobs; corn cob fractions including light density pith core, corn cob ground woody ring portion, corn cob coarse or fine chaff portion; cotton seed stems; flax stems; wheat stems; sunflower seed stems; soybean stems; maize stems; rye grass stems; millet stem; gilsonite; asphaltine; waxes; and calcium carbonate.

15. A drilling fluid composition as in claim 12 wherein the weighting materials are selected from any one of or a combination of barite, barium sulfate, calcium carbonate, galena, hematite, magnetite, iron oxides, ilmenite, siderite, celestite, dolomite, calcite, manganese oxides, zinc oxide and zirconium oxides.

16. A drilling fluid composition as in claim 12 wherein the gelling agents are selected from any one of or a combination of starch or derivatized starches and chemically modified starches including carboxymethyl starch, hydroxyethyl starch, hydroxypropyl starch, acetate starch, sulfamate starch, phosphate starch, nitrogen modified starch, starch cross-linked with aldehydes, epichlorohydrin, borates, and phosphates.

17. A method for ameliorating seepage loss while drilling a subterranean well comprising the steps of:
c. monitoring seepage loss while drilling;
d. circulating a synthetic oil, oil, or water based drilling mud into the drill string wherein the drilling fluid comprises a liquid carrier and an additive of ground pumice, barite, anthracite or dolomite or a combination thereof and wherein the liquid carrier is a synthetic, oil, or water based drilling mud and the additive is added to the liquid carrier at a concentration of greater then 0.01 pounds per barrel of liquid carrier.

18. A method as in claim 17 wherein the additive is barite and the concentration is 0.01-700 ppb.

19. A method as in claim 17 wherein the additive is pumice and the concentration is 0.01-300 ppb.

20. A method as in claim 17 wherein the additive is dolomite and the concentration is 0.01-300 ppb.

21. A method as in claim 17 wherein the additive is anthracite and the concentration is 0.01-300 ppb.

22. A method as in claim 17 wherein the concentration is less than 48% by volume additive in liquid carrier.

23. A method as in claim 17 wherein the additive has an average particle size between 100 and 4000 microns.

24. A method as in claim 17 wherein the concentration of additive is increased during circulation.

25. A method as in claim 17 wherein step b) is initiated with an additive having an average particle size in the lower half of the range of 100-4000 microns and wherein step b) is repeated with an additive having a larger average particle size than the lower half.

26. A method as in claim 17 wherein step b) is initiated with an additive having an average particle size in the upper half of the range of 100-4000 microns and wherein step b) is repeated with an additive having a smaller average particle size than the upper half.

27. A method as in claim 17 wherein step b) is initiated with an additive having an average particle size in the lower quartile of the range of 100-4000 microns and wherein step b) is repeated with an additive having a larger average particle size than the lower quartile.

28. A method as in claim 17 wherein step b) is initiated with an additive having an average particle size in the upper quartile of the range of 100-4000 microns and wherein step b) is repeated with an additive having a smaller average particle size than the upper quartile.

29. A method of recognizing and controlling an underground blowout in a subterranean formation comprising the steps of:
e. monitoring surface pressure within a well to detect a pressure increase indicating fluid influx into the well;
f. closing in the well in response to the pressure increase;
g. monitoring surface pressure and detecting an underground blowout if well pressure drops and fluid loss increases above threshold values;
h. circulating a drilling fluid composition comprising a liquid carrier and a drilling fluid additive including any one of or a combination of ground pumice, barium, anthracite or dolomite having an average particle size between 100 and 4000 microns; and,
i. monitoring the fluid loss and adjusting the size and/or concentration of drilling fluid additive in response to changes or lack of changes in the fluid loss.

30. A proppant for use in downhole fracturing comprising any one of or a combination of ground pumice, barium, anthracite and dolomite wherein the pumice, barium, anthracite or dolomite having an average particle size between 100 and 35,000 microns.

31. A proppant as in claim 30 wherein the proppant is anthracite.

32. A proppant as in claim 30 wherein the proppant is pumice.
